(19) United States
(12) Patent Application Publication
(10) Pub. No.: US 2020/0350807 A1
(43) Pub. Date: Nov. 5, 2020

(54) METHOD AND DEVICE FOR PRODUCING A STATOR

(71) Applicant: Miba Automation Systems Ges.m.b.H., Laarkirchen (AT)

(72) Inventors: Andreas Falkner, Wels (AT); Mladen-Mateo Primorac, St. Pölten (AT); David Scherrer, Gmunden (AT)

(21) Appl. No.: 16/643,512

(22) PCT Filed: Aug. 10, 2018
(86) PCT No.: PCT/AT2018/060187

§ 371 Date: Feb. 28, 2020

(30) Foreign Application Priority Data
Sep. 1, 2017 (AT) A50738/2017

(51) Int. Cl. H02K 15/02; G01B 11/26

(52) U.S. Cl. CPC H02K 15/026; G01B 11/26

(57) ABSTRACT

The invention relates to a method for automatedly manufacturing a stator component, as well as a device for manufacturing a stator component comprising at least one hollow-cylindrical stator pack having a plurality of rod-shaped electrical conductor elements inserted into the stator pack, said conductor elements projecting substantially to the same distance out of the stator pack at the base side as conductor ends while at the front side the conductor ends project out of the stator pack according to their respectively prescribed length, and wherein the stator pack has at least one positioning mark, which is placed in the outer lateral surface of the stator pack and extends in the direction of the main axis of the stator pack and which serves for orienting and positioning the stator pack with respect to at least one forming tool.

The invention relates to a method for automatedly manufacturing a stator component, as well as a device for manufacturing a stator component comprising at least one hollow-cylindrical stator pack having a plurality of rod-shaped electrical conductor elements inserted into the stator pack, said conductor elements projecting substantially to the same distance out of the stator pack at the base side as conductor ends while at the front side the conductor ends project out of the stator pack according to their respectively prescribed length, and wherein the stator pack has at least one positioning mark, which is placed in the outer lateral surface of the stator pack and extends in the direction of the main axis of the stator pack.

A stator of an electrical machine usually comprises several coils which are flown through by current for generating a rotating electrical field in a stator pack. The sum of coils is referred to as winding. For forming such coils, the introduction, twisting and cross-linking of essentially rod-shaped electrical conductor elements is known. The rod-shaped electrical conductor elements are inserted into internal grooves in a stator pack that are provided for this purpose in such a way that one or more conductor elements are arranged in a row in radial alignment within each internal groove. The arrangement of the conductor elements within the stator pack hence prescribes a relative end position of the conductor ends protruding from the base side and/or front side of the stator pack, which are to be interconnected after a subsequent twisting process. In the twisting process, the conductor ends of at least two radially adjacent layers of conductor elements are bent in and/or against the circumferential direction by means of at least one forming tool in such a way that the corresponding conductor ends are aligned in the radial direction. By the subsequent interconnection a part of the conductor ends is interconnected to corresponding conductor ends of the conductor elements of other layers. The relative position of the conductor elements in the stator pack must therefore necessarily be brought into agreement with the relative position of the recesses provided for this purpose in the at least one forming tool, since it ultimately corresponds to the relative position of the conductor ends of the finished stator. For this purpose, DE 10 2015 217 936 A1 suggests that in a positioning process a forming tool is moved to a first rotational position and each conductor end of a first group of conductor elements of a layer is inserted into a recess of the forming tool. It is further described that the forming tool is rotated into at least one further rotational position and each conductor end of a further group of conductor elements of a layer is inserted into one of the receiving areas. In total, as many groups are provided until the conductor ends of all conductor elements have the relative end position to one another, by each conductor end being inserted into a recess of the forming tool. By rotating the forming tool between the insertion of further conductor ends in receiving areas, the conductor ends already inserted in the receiving areas are each rotated by a predetermined angle of rotation about the axis of the stator, whereby different rotation angles or positions can be set for different groups of conductor elements. The method described in DE 10 2015 217 936 A1 thus allows for positioning conductor elements within a forming tool such that a prescribed end position of the conductor elements, which is required for correct interconnection of the stator, is maintained.

It was the object of the present invention to overcome the disadvantages of the prior art and to provide a device and a method, by means of which a user is capable of performing easy manufacture of a stator component for an electrical drive. In particular, in this regard, the processes during manufacturing are to be optimized such that a significant reduction of process times and an increase of process safety can be allowed for.

This object is achieved by means of a device and a method according to the claims.

According to the invention, a method for automatedly manufacturing a stator component is provided. The method comprises the steps:
providing a hollow-cylindrical stator pack having a plurality of stator laminations stacked in the direction of the main axis of the stator pack, comprising a plurality of internal grooves extending in the direction of the main axis of the stator pack, arranged to be distributed in the circumferential direction and extending continuously from a base side to a front side of the stator pack on the inside of the hollow-cylindrical stator pack, said internal grooves being each equipped with a rod-shaped electrical conductor element such that the rod-shaped electrical conductor elements project substantially to the same distance out of the stator pack at the base side as conductor ends while at the front side the rod-shaped electrical conductor elements project out of the stator pack as conductor ends according to their respectively prescribed length, and the stator pack has at least one positioning mark, which is placed in the outer lateral surface of the stator pack and extends in the direction of the main axis of the stator pack,
providing at least one forming tool, which for receiving the respective front-side conductor ends comprises recesses distributed in the circumferential direction around a main tool axis, wherein the at least one forming tool is designed to be displaceable at least along the main tool axis,
positioning the stator pack in a holding device,

wherein in the method according to the invention
the stator pack is picked up by means of a gripping device of a gripping apparatus which is displaceable in the direction of the main axis of the stator pack and rotatable in the circumferential direction of the stator pack,
the stator pack is rotated in the circumferential direction about the main axis of the stator pack, whereby the positioning of the plurality of rod-shaped electrical conductor elements is brought into agreement with the recesses provided for this purpose in the at least one forming tool by means of the positioning mark placed in the lateral surface of the stator pack,
at least parts of the lateral surface of the stator pack are detected by means of an optical sensor unit,
the angular position of the stator pack is determined by means of the at least one positioning mark,
the calculation of correction values for the orientation of the stator pack about the main axis of the stator pack is carried out by means of system control,
an angle correction of the stator pack is carried out by rotating the gripping device about the main axis of the stator pack until the conductor ends of the stator pack projecting from the stator pack are aligned with the position of the recesses of the at least one forming tool, which are distributed correspondingly in the circumferential direction about the main tool axis,
the stator pack is positioned in the holding device by means of a gripping device according to a predetermined position in the direction of the main axis of the stator pack. The specified approach allows for correct alignment of the conductor ends of a stator pack equipped with conductor elements with respect to the at least one forming tool for subsequent forming operations of the conductor elements with maximum positioning precision. There is no need to load the laminated core and/or the forming tool within the forming device, which offers significant advantages. By the automated method the process time for the alignment operation of the conductor ends with respect to the forming tool is significantly reduced and manual actions of a plant operator are entirely avoided, whereby the process safety and quality of the manufactured stator component can be increased. Moreover, the method enables a large number of stator packs equipped with conductor elements to be stored in e.g. a pre-material store, which the gripping apparatus can access if required. Consequently, the overall process time is reduced, since loading the forming tool with conductor elements within the plant is completely eliminated.

Moreover, it may be useful if as at least one positioning mark placed in the direction of the main axis of the stator pack, a positioning mark extending from the base side over at least 10%, preferably 25% of the height of the stacked stator laminations is used in the lateral surface of the stator pack. It has been shown that a longitudinal extension of the positioning mark compared to a punctiform marking can significantly improve the response accuracy of the sensor unit.

It can further be provided for that a positioning mark placed in the lateral surface of the stator pack in the direction of the main axis of the stator pack, is a positioning groove with a V- or U-shaped cross-section with two longitudinal edges extending in the direction of the main axis of the stator pack.

By using V- or U-shaped positioning grooves, only a small amount of material is removed from the stator pack as compared to a rectangular groove, whereby the magnetic flux within the stator pack is minimally disturbed. Furthermore, the use of straight edges facilitates position detection by means of an optical sensor unit, which increases process safety.

In addition, it can be provided that, in order to determine a reference position of the at least one positioning mark placed in the direction of the main axis of the stator pack, the measurement of the two longitudinal edges of the positioning groove which is V- or U-shaped in cross-section extending in the direction of the main axis of the stator pack is carried out and the center of the two edge positions in the circumferential direction is used as a reference position. The use of V- or U-shaped positioning grooves as positioning marks has the advantage that these two cross-sectional geometries each have a “lowest point”, which is particularly suitable for the exact determination of the reference position.

A design according to which it can be provided for that a contrast sensor is used as the optical sensor unit for the method is also advantageous.

In accordance with the constructional size of the stator component, the use of contrast sensors has proven to be very useful and cost-effective for larger dimensions of the stator pack.

However, according to a further development, it is possible to use a laser sensor as the optical sensor unit. Laser sensors are particularly advantageous due to the high measuring frequency and the long range with excellent spatial resolution. Furthermore, possible stray light effects caused by e.g. ambient light can be avoided as far as possible.

Moreover, it may be useful if, during the detection of the lateral surface of the stator pack, the optical sensor unit measures an angular range of more than 5° over the circumference of the lateral surface of the stator pack as well as a length in the direction of the main axis of the stator pack starting from the base side of the stator pack of at least 10%, preferably 25%. By using a measuring range instead of detecting individual points on the lateral surface, the accuracy of position detection by means of an optical sensor unit is increased. Furthermore, the size of the simultaneously measured surface of the stator pack has a positive effect on the required alignment time.

Moreover, it can be provided for that the alignment of the stator pack in the direction of the main axis of the stator pack is carried out such that the base side of the stator pack is brought into contact with a stop provided in the holding device. This approach represents a simple and cost-effective method for positioning the stator pack correctly in the direction of the main axis of the stator pack and for placing it in a suitable manner for subsequent forming operations. Subsequent forming of the base-side conductor ends is facilitated by the fact that the base-side conductor ends protrude from the stator pack with the same length.

Furthermore, it can be provided for that after the angle correction, the holding device clamps the stator pack and the gripping device releases the stator pack. By clamping the stator pack, slippage in the direction of the main axis of the stator pack as well as in the circumferential or transverse direction is prevented. Furthermore, this clamping enables a movement of the holding device without having to carry out a further alignment process of the stator pack.

It can also be provided that after clamping the stator pack, the holding device is displaced perpendicularly to the main axis of the stator pack until the main axis of the stator pack is aligned with the main tool axis of the at least one forming tool. This enables the gripping apparatus to be designed more cost-effectively and not, for example, as a multi-axis robot unit. This enables an efficient and cost-effective design of the device for manufacturing a stator component.

According to a particular embodiment, it is possible that after clamping of the stator pack, the at least one forming tool is moved to the stator pack in the direction of the main axis of the stator pack and encloses the conductor ends with the recesses provided for this purpose at the front side. Due to the predetermined position of the recesses of the at least one forming tool relative to the corresponding conductor ends of the stator pack, which are aligned in the circumferential direction and in the direction of the main axis of the stator pack, safe approaching of the at least one forming tool is possible. A significant reduction of the process time is thus achieved.

In accordance with an advantageous further development, it can be provided that a locking means is brought into contact with the at least one positioning mark placed in the direction of the main axis of the stator pack. Hence, rotation of the stator pack about its circumferential direction is prevented, which is of particular significance for the sequential forming of several layers or planes of conductor ends.

According to the invention, a device for automatedly manufacturing a stator component comprising at least one hollow-cylindrical stator pack having a plurality of stator laminations stacked in the direction of the main axis of the stator pack, and having a plurality of internal grooves extending in the direction of the main axis of the stator pack, arranged to be distributed in the circumferential direction and extending continuously from a base side to a front side on the inside of the hollow-cylindrical stator pack, said internal grooves being each equipped with a rod-shaped electrical conductor element and wherein on the base side, the rod-shaped electrical conductor elements are formed as conductor ends projecting substantially to the same distance out of the stator pack while at the front side the rod-shaped electrical conductor elements project out of the stator pack as conductor ends according to their respectively prescribed length, and the stator pack has at least one positioning mark, which is placed in the outer lateral surface of the stator pack and extends in the direction of the main axis of the stator pack, wherein the device comprises the following particular features:
at least one holding device suitable for fixation of the hollow-cylindrical stator pack,
at least one gripping apparatus comprising a gripping device suitable for the transport and/or positioning of the hollow-cylindrical stator pack to and/or within the holding device, wherein the device for manufacturing stator components in particular provides for:
the at least one gripping device is suitable for clamping the hollow-cylindrical stator pack on its inner side and the gripping apparatus has at least one drive unit which is designed to be displaceable for positioning along the direction of the main axis of the stator pack as well as perpendicularly to the direction of the main axis of the stator pack, has at least one further drive unit which is suitable for positioning the stator pack in the circumferential direction and
at least one optical sensor unit is mounted on or within the gripping apparatus, said sensor unit facing the gripping device and consequently the lateral surface of the received laminated core. The described device allows for the stator pack to be simultaneously rotated about its main axis and the lateral-surface contour being measured. Furthermore, the spatial proximity of the attachment of the optical sensor unit to the gripping apparatus and/or the gripping device has the advantage that the measuring and aligning process of the stator pack can already take place directly after the stator pack has been picked up by the gripping device, since the optical sensor unit is attached in direct line of sight to the gripping device and thus to the lateral surface of the clamped stator pack, which reduces the required process time.

It can further be provided for that the at least one optical sensor unit is a contrast sensor, which allows for cost-effective design of the device.

Moreover, it can be provided for that the at least one optical sensor unit is a laser sensor. The high measuring frequency and range with excellent spatial resolution of laser optics are particularly advantageous in this regard. Moreover, hence, possible stray light effects caused by e.g. ambient light can be avoided as far as possible.

A design according to which it can be provided for that a protective device transparent for the optical sensor unit is attached between the at least one optical sensor unit and the gripping device of the gripping apparatus is also advantageous. In order to prevent potential impurities on the optical sensor unit by e.g. dust from the environment, or mechanical damage, the installation of a protective device has proven successful; if necessary, it can be replaced easily and economically without having to replace the entire optical sensor unit.

According to a further development, it is possible that the optical sensor unit is connected to the gripping device via an electronic system control. The use of an electronic system control enables a quick and/or automated adjustment of the given reference values for the surface area of a stator pack to be measured, which is particularly important for different sizes of stator packs in the direction of the main axis of the stator pack or also in the radial direction, since a time-consuming calibration of the optical sensor unit only has to be carried out once.

It may also be useful if the holding device is provided with a locking means displaceable perpendicularly to the direction of the main axis of the stator pack placed positioning mark. By means of the locking means, which can be designed e.g. as a bolt, slider or the like, a twisting of the stator pack around its circumferential direction is prevented, which is particularly important in the sequential forming of several layers or planes of conductor ends.

Moreover, it can be provided for that the holding device is displaceable perpendicularly to the main axis of the stator pack. By using a displaceable holding device with an already pre-aligned stator pack, the positioning of the stator pack and/or the aligned conductor ends with their main axis of the stator pack can be aligned with the main tool axis of the at least one forming tool in a very simple and positionally accurate manner, since the displacement direction of the holding device is essentially parallel to the main axis of the stator pack. Thereby, the complexity of the device is considerably reduced as compared to the use of a multi-axis gripping apparatus, which e.g. as a robot arm takes over the positioning of the stator pack in circumferential direction, in the direction of the main axis of the stator pack, as well as the agreement of the main axis of the stator pack with the main tool axis. This results in a smaller total device area and lower costs.

The system control may be formed by any conceivable type of controller. This may be, for example, an industrial computer, a programmable logic controller or any other controller suitable for converting the data acquired by the optical sensor unit(s) into movement and/or position commands for the device used to manufacture a stator component. In this context, inter alia, the following are connected to the electronic system control: the gripping apparatus, the gripping device, the holding device, the optical sensor(s).

For the purpose of better understanding of the invention, it will be elucidated in more detail by means of the figures below.

These show in a respectively very simplified schematic representation:

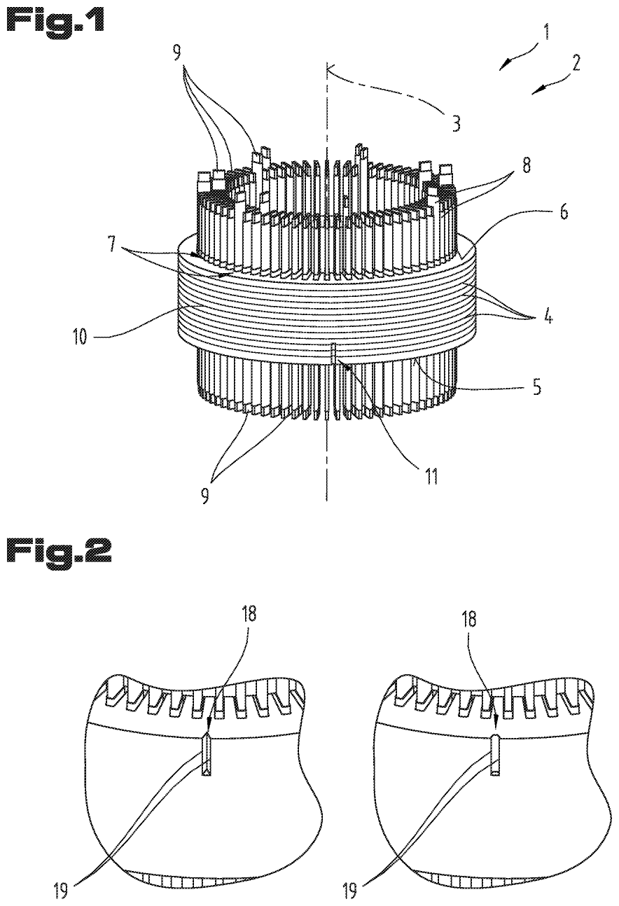

FIG. 1 a perspective view of a stator component;

FIG. 2 a perspective view of positioning marks designed as V- and/or U-shaped positioning grooves;

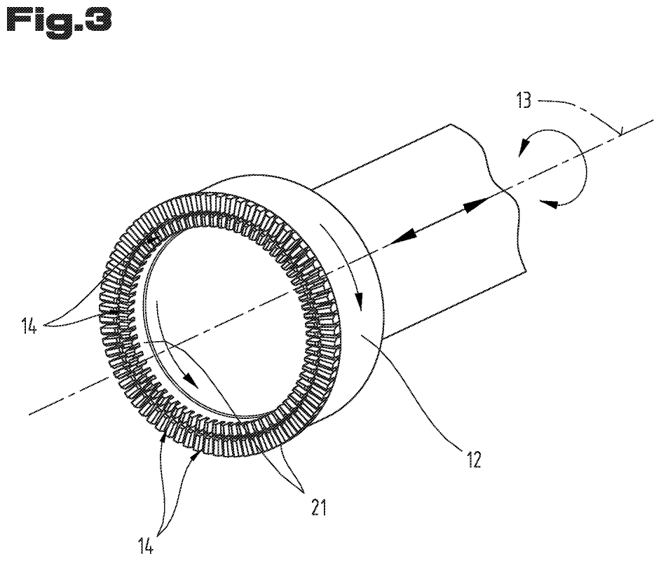

FIG. 3 a perspective view of a combined forming tool;

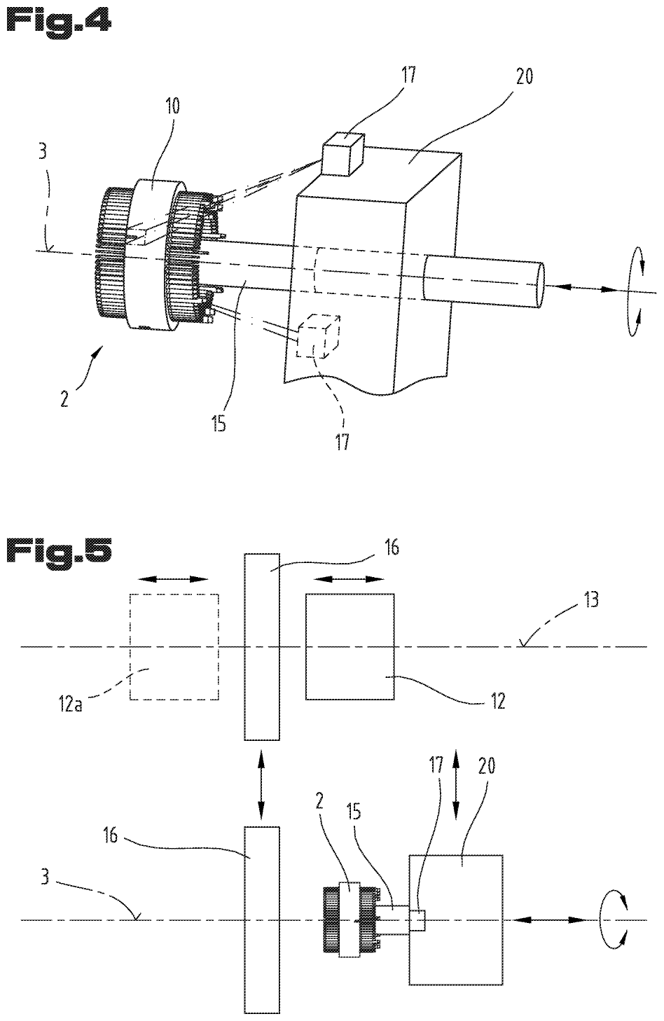

FIG. 4 a perspective representation of a gripping apparatus with a gripping device and a spanned stator pack as well as two possible positions for attaching an optical sensor unit;

FIG. 5 a layout of a possible design of a device for manufacturing a stator component.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows a simplified perspective view of a stator componentl, which in the context of the present application is to be understood as a pre-product for manufacturing a stator for an electric drive unit. The stator component 1 comprises a hollow-cylindrical stator pack 2, which has a main axis of the stator pack 3 along its axis of rotation. The stator pack 2 comprises a plurality of stator laminations 4 stacked in the direction of the main axis of the stator pack 3. The stator pack 2 comprises a plurality of internal grooves 7, which are arranged on the inside of the stator pack 2 to be distributed in the circumferential direction and extend continuously from a base side 5 to a front side 6. These internal grooves serve to accommodate at least one rod-shaped electrical conductor element 8 each. If the stator pack 2 is to be designed with several layers, the rod-shaped electrical conductor elements 8 are positioned in the respective inner grooves 7 in such a way that they are aligned in the radial direction and are electrically insulated from one another. In the case of the stator pack 2 shown as an example in FIG. 1, two rod-shaped electrical conductor elements 8 are used in each of the internal grooves 7, which corresponds to a two-layer winding. Depending on the size of the stator component 1, the number of stator laminations 4 as well as the lengths of the rod-shaped electrical conductor elements 8 can vary. However, the rod-shaped electrical conductor elements 8 used here can also have different lengths within the design of a stator pack 2, as they can each be provided as part of a coil and/or a connection in the finished stator. The relative arrangement of the individual rod-shaped electrical conductor elements 8 is thus defined by their later use and determines their position in the circumferential and radial directions in the stator pack 2. The lengths of the individual rod-shaped electrical conductor elements 8 are specified in the same way. The rod-shaped electrical conductor elements 8 project as conductor ends 9 with essentially the same length on the base side 5, while on the front side 6 the rod-shaped electrical conductor elements 8 project as conductor ends 9 from the stator pack 2 according to their respective prescribed length.

The stator pack 2 shown in FIG. 1 moreover comprises a lateral surface 10 in which at least one positioning mark 11 placed from the base side 5 in the direction of the main axis of the stator pack 3 extends. This at least one positioning mark 11 serve as a reference mark, by means of which the rod-shaped electrical conductor elements 8 arranged in the stator pack 2 can be assigned a distinct position in the circumferential and radial direction by their predetermined arrangement.

FIG. 2 shows two exemplary embodiments of positioning marks 11 in the form of positioning grooves 18. The left representation corresponds to a positioning groove 18 with a V-shaped cross-section, while the right representation shows a positioning groove 18 with a U-shaped cross-section. The positioning grooves 18 each have two straight longitudinal edges 19 in the direction of the main axis of the stator pack. By such positioning marks 11, the detection of the angular position about the main axis of the stator pack 3 of the stator pack 2 is made possible in a simple manner by means of at least one optical sensor unit 17.

FIG. 3 shows a schematic representation of a forming tool 12 having a main tool axis 13. In the shown example, the forming tool 12 is designed to have two rows, which means that two counter-rotating forming tools 12 each have a number of recesses 14 distributed around the main tool axis 13 in the peripheral direction. The two-row design of the forming tool 12 thus corresponds to the two-layer winding of the stator pack 2. A higher number of layers thus requires a correspondingly higher number of part tools 21 at the head of the forming tool 12. However, the number and arrangement of the recesses 14 of the forming tool 12 always corresponds to the number and arrangement of the rod-shaped electrical conductor elements 8 of the stator pack 2. In the starting position for the forming process, the at least one forming tool 12 is brought into a reference position. Furthermore, the forming tool 12 should be displaceable in the direction of its main tool axis 13 and the part tools 21 should be designed so as to be rotatable in and/or against the circumferential direction.

FIG. 4 shows a gripping device 20 on the gripping apparatus 15 of which a stator pack 2 is spanned. The gripping apparatus 20 should have at least one drive device (not shown) which enables the gripping device 15 to rotate about the main axis of the stator pack 3. Furthermore, the gripping apparatus 20 should be equipped with at least one further drive unit (not shown) which enables a displacement of the gripping device 15 in the direction of the main axis of the stator pack 3. The gripping apparatus 20 can also comprise further drives and/or devices to enable, for example, rotation and/or displacement of the stator pack 2 in the vertical and/or horizontal direction. Accordingly, the gripping device 20 can be designed as a multi-axis robot device. As can also be seen in FIG. 4, at least one optical sensor unit 17 should be attached to or within (shown hatched) the gripping device 20. The optical sensor unit 17 is mounted in such a way that there is an unobstructed line of sight to the gripping device 15 and thus to the lateral surface 10 of a spanned stator pack 2.

FIG. 5 shows a schematic layout of a particular embodiment of a device for manufacturing a stator component 1.

As can be seen in FIG. 5, the main axis of the stator pack 3 and the main tool axis 13 are aligned parallel to each other, which can be compensated for by a holding device 16 displaceable perpendicularly to the main axis of the stator pack 3. Moreover, a second forming tool 12 is adumbrated schematically. This second forming tool 12 can be used for simultaneously forming the base-side conductor ends 9 if forming the front-side conductor ends 9 is performed by means of the first forming tool 12.

Below, the method for producing a stator component 1 according to the invention will be described.

In a first method step, a hollow-cylindrical stator pack 2 comprising the aforementioned features is provided.

In a second method step, at least one forming tool 12 is provided.

In a third method step, the stator pack 2 is positioned such by a holding device 16 that a subsequent method step of forming the conductor ends 9 is allowed for. In this third method step, several partial steps are carried out, wherein

a) the stator pack 2 is clamped on the inside by means of a gripping device 15 and thus temporarily fixed for the measuring and positioning process;

b) the stator pack 2 is then rotated about the main axis of the stator pack 3 and the lateral surface 10 of the stator pack 2 is captured by means of an optical sensor unit 17;

c) the angular position of the stator pack 2 is determined by means of the at least positioning mark 11;

d) the calculation of correction values for the alignment of the stator pack 2 around the main axis of the stator pack 3 is carried out by means of a system control (not further described), wherein the predetermined relative position of the conductor ends 9 of the stator pack 2 projecting from the stator pack 2 are compared to the position of the recesses 14 of the at least one forming tool 12, which recesses are distributed correspondingly in the circumferential direction around the main tool axis 13;

e) an angular correction of the stator pack 2 is then carried out by rotating the gripping device 15 about the main axis of the stator pack 3 until the predetermined position of the conductor ends 9 is aligned with the position of the recesses 14 of the at least one forming tool 12;

f) as soon as the reference position of the stator pack 2 has been assumed, the stator pack 2 is positioned in the holding device 16 by means of the gripping device 15 in accordance with a predetermined position in the direction of the main axis of the stator pack 3.

As can be seen from FIGS. 1 and 2, the positioning mark 11 placed in the direction of the main axis of the stator pack 3 in the lateral surface 10 of the stator pack 2 should have at least 10%, preferably 25%, of the height of the stacked stator laminations 4 starting from the base side 5. In the example shown in FIG. 1, a stator component 1 with approximately 80 stator laminations 4 is represented schematically. Depending on the stator type, stator components 1 with a considerably higher number (e.g. 120 to 480) of stator laminations 4 may be required. For this purpose, it can be advantageous if more than one positioning mark 11 is placed in the lateral surface 10 of the stator pack 2, as is schematically adumbrated in FIG. 4. It proved advantageous if, in the case of the use of several positioning marks 11, all of these have the same length and are offset by 90° in the circumferential direction in each case, as well as offset by a length of the positioning mark 11 in the direction of the main axis of the stator pack 3 in each case, are placed in the lateral surface 10, which allows for an assignment of the used stator packs 2 to a certain stator type. The positioning process of the stator pack 2 is carried out in the manner described above independently of the size of the stator pack 2 and uses the positioning mark 11, which starts out from the base side 5, for determining the reference position.

As can particularly well be seen from FIG. 2, the use of positioning grooves 18 having a V-shape or a U-shape in cross section as positioning marks 11 can be advantageous. The positioning grooves 18 that are V- or U-shaped in cross-section are easy to place in the lateral surface 10 of the stator pack 2 for manufacturing purposes and each comprise two longitudinal edges 19 extending in the direction of the main axis of the stator pack 3. These longitudinal edges 19 should run in a straight line in order to be best suited for measurement by means of an optical sensor unit 17, wherein the center of the two edge positions in the circumferential direction is used as a reference position.

A contrast sensor can be used as the at least one optical sensor unit 17 to measure and determine the position of the positioning mark 11. A combination of a contrast sensor with one or more contrast sensors which are used for measuring the stator pack 2 is conceivable. The combination of one or more contrast sensors with one or more laser sensors is also conceivable, as is the sole use of laser sensors as at least one optical sensor unit 17.

As can be seen particularly well in FIG. 5, the stator pack 2 has the same main axis (main axis of the stator pack 3) as the rotation axis of the gripping device 15.

In the version shown, a gripping apparatus 20 is shown which the gripping device 15 can rotate in the circumferential direction of the stator pack 2 and which can be moved in the direction of the main axis of the stator pack 3.

A positioning of the aligned stator pack 2 within a predetermined position of the holding device 16 can hence be realized in an easy manner.

In this regard, the base side 5 of the stator pack 2 is brought into contact with a stop (not shown) provided in the holding device 16.

The stator pack 2 is then clamped inside the holding device 16 by means of, for example, several clamping jaws or by means of a conductor element holder (not shown) present on the base side and the gripping device 15 releases the stator pack 2.

In a particular embodiment, the holding device 16 is displaced perpendicularly to the main axis of the stator pack 3 until the main axis of the stator pack 3 is aligned with the main tool axis 13 of the at least one forming tool 12, 12a.

Then, the at least one forming tool 12 can be moved in the direction of the main axis of the stator pack 3 and/or its main tool axis 13 in order to enclose the conductor ends 9 protruding from the front side of the aligned stator pack 2 with the recesses 14 provided for this purpose in the at least one forming tool 12. Analogously, a further forming tool 12 a can be moved to the base side 5 of the stator pack 2.

In particular, it can be provided for that a locking means 22 (not shown) is brought into contact with the at least one positioning mark 11 placed in the direction of the main axis of the stator pack 3 and/or at least one of the positioning grooves 18 which are V- or U-shaped in cross-section. This locking means 22 can, for example, be designed as a bolt, slider, spring or the like and be mounted accordingly inside the holding device 16.

A schematic diagram of a device for automatedly manufacturing a stator component 1 is shown in FIG. 5. The device should comprise at least the following features:

at least one holding device 16 suitable for fixation of the hollow-cylindrical stator pack 2,

at least one gripping apparatus 20 comprising a gripping device 15 suitable for the transport and/or positioning of the hollow-cylindrical stator pack 2 to and/or within the holding device 16, wherein

the at least one gripping device 15 is suitable for clamping the hollow-cylindrical stator pack 2 on its inner side and the gripping apparatus 20 has at least one drive unit which is designed to be displaceable for positioning along the direction of the main axis of the stator pack 3 as well as perpendicularly to the direction of the main axis of the stator pack 3, and has at least one further drive unit which is suitable for positioning the stator pack 2 in the circumferential direction and

at least one optical sensor unit 17 is mounted on or within the gripping apparatus 20, said sensor unit 17 facing the gripping device 15 and consequently the lateral surface 10 of the received laminated core 2.

The multi-axiality of the gripping apparatus 20 and/or the gripping device 15 can be achieved in particular by designing the gripping apparatus 20 as a multi-axial robot.

In a particular embodiment the at least one optical sensor unit 17 should be connected to the gripping device 15 of the gripping apparatus 20 via an electronic system control.

It can further be provided for that a protective device (not shown) invisible for the optical sensor unit 17 is attached between the optical sensor unit 17 and the gripping device 15. The person skilled in the art can select suitable materials for the protective device that correspond to the construction of the optical sensor unit, e.g. silicate glass, plastic materials or suitable ceramics.

In an alternative embodiment variant, the holding device 16 can be designed to be displaceable perpendicularly to the main axis of the stator pack 3. It is clear to the person skilled in the art that this design requires a reduced complexity of the gripping apparatus 20. As shown schematically in FIG. 5, for the alignment of the main axis of the stator pack 3 with the main tool axis 13, a holding device 16 that can be moved horizontally and/or perpendicularly to the main axis of the stator pack 3 is used instead of a gripping apparatus 20 that must be designed such that it can move in several axes.

Furthermore, it can be provided for that a raw material storage is provided within the reach of the gripping apparatus 20. In this raw material storage (not shown) a plurality of stator packs 2 equipped with conductor elements 8 can be stored, which the gripping apparatus 20 can access if required.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the teaching for technical action provided by the present invention lies within the ability of the person skilled in the art in this technical field.

The scope of protection is determined by the claims. However, the description and the drawings are to be adduced for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### LIST OF REFERENCE NUMBERS

1 stator component

2 stator pack

3 main axis of the stator pack

4 stator lamination

5 base side

6 front side

7 internal groove

8 conductor element

9 conductor end

10 lateral surface

11 positioning mark

12 forming tool

13 main tool axis

14 recess

15 gripping device

16 holding device

17 sensor unit

18 positioning groove

19 longitudinal edge

20 gripping apparatus

21 part tool

22 locking means

1. A method for automatedly manufacturing a stator component, comprising the steps:
providing a hollow-cylindrical stator pack having a plurality of stator laminations stacked in the direction of the main axis of the stator pack, comprising a plurality of internal grooves extending in the direction of the main axis of the stator pack, arranged to be distributed in the circumferential direction and extending continuously from a base side to a front side of the stator pack on the inside of the hollow-cylindrical stator pack, said internal grooves being each equipped with a rod-shaped electrical conductor element such that the rod-shaped electrical conductor elements project substantially to the same distance out of the stator pack at the base side as conductor ends while at the front side the rod-shaped electrical conductor elements project out of the stator pack as conductor ends according to their respectively prescribed length, and the stator pack has at least one positioning mark, which is placed in the outer lateral surface of the stator pack and extends in the direction of the main axis of the stator pack,
providing at least one forming tool, which for receiving the respective front-side conductor ends comprises recesses distributed in the circumferential direction around a main tool axis, wherein the at least one forming tool is designed to be displaceable at least along the main tool axis,
positioning the stator pack in a holding device, wherein:
the stator pack is picked up by means of a gripping device of a gripping apparatus which is displaceable in the direction of the main axis of the stator pack and rotatable in the circumferential direction of the stator pack,
the stator pack is rotated in the circumferential direction about the main axis of the stator pack, whereby the positioning of the plurality of rod-shaped electrical conductor elements is brought into agreement with the recesses provided for this purpose in the at least one forming tool by means of the positioning mark placed in the lateral surface of the stator pack,
at least parts of the lateral surface of the stator pack are detected by means of an optical sensor unit,
the angular position of the stator pack is determined by means of the at least one positioning mark,
the calculation of correction values for the orientation of the stator pack about the main axis of the stator pack is carried out by means of system control,
an angle correction of the stator pack is carried out by rotating the gripping device about the main axis of the stator pack until the conductor ends of the stator pack projecting from the stator pack are aligned with the position of the recesses of the at least one forming tool, which are distributed correspondingly in the circumferential direction about the main tool axis,
the stator pack is positioned in the holding device by means of a gripping device according to a predetermined position in the direction of the main axis of the stator pack.

2. The method according to claim 1, wherein as at least one positioning mark placed in the direction of the main axis of the stator pack, a positioning mark extending from the base side over at least 10%, preferably 25% of the height of the stacked stator laminations is used in the lateral surface of the stator pack.

3. The method according to claim 1, wherein, a positioning mark placed in the lateral surface of the stator pack in the direction of the main axis of the stator pack, is a positioning groove with a V- or U-shaped cross-section with two longitudinal edges extending in the direction of the main axis of the stator pack.

4. The method according to claim 3, wherein in order to determine a reference position of the at least one positioning mark placed in the direction of the main axis of the stator pack, the measurement of the two longitudinal edges of the positioning groove which is V-shaped or U-shaped in cross-section extending in the direction of the main axis of the stator pack is carried out and the center of the two edge positions in the circumferential direction is used as a reference position.

5. The method according to claim 1, wherein a contrast sensor is used as the optical sensor unit.

6. The method according to claim 1, wherein a laser sensor is used as the optical sensor unit.

7. The method according to claim 1, wherein during the detection of the lateral surface of the stator pack, the optical sensor unit measures an angular range of more than 5° over the circumference of the lateral surface of the stator pack as well as a length in the direction of the main axis of the stator pack starting from the base side of the stator pack of at least 10%, preferably 25%.

8. The method according to claim 1, wherein the alignment of the stator pack in the direction of the main axis of the stator pack is carried out such that the base side of the stator pack is brought into contact with a stop provided in the holding device.

9. The method according to claim 1, wherein after the angle correction, the holding device clamps the stator pack and the gripping device releases the stator pack.

10. The method according to claim 9, wherein after clamping of the stator pack, the holding device is displaced perpendicularly to the main axis of the stator pack until the main axis of the stator pack is aligned with the main tool axis of the at least one forming tool.

11. The method according to claim 1, wherein after clamping of the stator pack, the at least one forming tool is moved to the stator pack in the direction of the main axis of the stator pack and encloses the conductor ends with the recesses provided for this purpose at the front side.

12. The method according to claim 9, wherein a locking means is brought into contact with the at least one positioning mark placed in the direction of the main axis of the stator pack.

13. A device for automatedly manufacturing a stator component of the kind including at least one hollow-cylindrical stator pack having a plurality of stator laminations stacked in the direction of the main axis of the stator pack, and having a plurality of internal grooves extending in the direction of the main axis of the stator pack, arranged to be distributed in the circumferential direction and extending continuously from a base side to a front side on the inside of the hollow-cylindrical stator pack, said internal grooves being each equipped with a rod-shaped electrical conductor element and wherein on the base side, the rod-shaped electrical conductor elements are formed as conductor ends projecting substantially to the same distance out of the stator pack while at the front side the rod-shaped electrical conductor elements project out of the stator pack as conductor ends according to their respectively prescribed length, and the stator pack has at least one positioning mark, which is placed in the outer lateral surface of the stator pack and extends in the direction of the main axis of the stator pack, the device comprising:
at least one holding device suitable for fixation of the hollow-cylindrical stator pack,
at least one gripping apparatus comprising a gripping device suitable for the transport and/or positioning of the hollow-cylindrical stator pack to and/or within the holding device, wherein characterized in that
the at least one gripping device is suitable for clamping the hollow-cylindrical stator pack on its inner side and the gripping apparatus has at least one drive unit which is designed to be displaceable for positioning along the direction of the main axis of the stator pack as well as perpendicularly to the direction of the main axis of the stator pack, and has at least one further drive unit which is suitable for positioning the stator pack in the circumferential direction and
at least one optical sensor unit is mounted on or within the gripping apparatus, said sensor unit facing the gripping device and consequently the lateral surface of the received laminated core.

14. The device according to claim 13, wherein the at least one optical sensor unit is a contrast sensor.

15. The device according to claim 13, wherein the at least one optical sensor unit is a laser sensor.

16. The device according to claim 13, wherein a protective device transparent for the optical sensor unit is attached between the at least one optical sensor unit and the gripping device of the gripping apparatus.

17. The device according to claim 13, wherein the optical sensor unit is connected to the gripping device via an electronic system control.

18. The device according to claim 13, wherein the holding device is provided with a locking means displaceable perpendicularly to the positioning mark (11) placed in the direction of the main axis of the stator pack.

19. The device according to claim 13, wherein the holding device is displaceable perpendicularly to the main axis of the stator pack.
